(19) United States
(12) Patent Application Publication
(10) Pub. No.: US 2013/0120877 A1
(43) Pub. Date: May 16, 2013

(54) HEAD IC AND MAGNETIC DISK APPARATUS HAVING MICROWAVE ASSISTANCE FUNCTION

(71) Applicant: KABUSHIKI KAISHA TOSHIBA, Tokyo (JP)

(72) Inventor: Yoshihiro AMEMIYA, Fussa-shi (JP)

(73) Assignee: KABUSHIKI KAISHA TOSHIBA, Tokyo (JP)

(21) Appl. No.: 13/725,892

(22) Filed: Dec. 21, 2012

Related U.S. Application Data
(63) Continuation of application No. 13/073,454, filed on Mar. 28, 2011.

(30) Foreign Application Priority Data
May 28, 2010 (JP) 2010-123535

(51) Int. Cl. G11B 5/127

(52) U.S. Cl. CPC G11B 5/127
USPC 360/128

(57) ABSTRACT

According to one embodiment, it is determined whether a STOAR element which performs microwave assistance for a magnetic disk apparatus is made to oscillate properly. When the STOAR element is oscillating when a current bias is applied, the resistance of the element increases. Therefore, in a head IC which outputs the current bias, a voltage applied to the STOAR element is sensed, and it is possible to determine that the STOAR element is oscillating when the voltage is increased to a threshold or more. Conversely, it is possible to determine that the STOAR element is not oscillating when the voltage is less than the threshold. In addition, it is possible to determine that oscillation has diminished, when the resistance decreases after the voltage reaches the threshold or more. Therefore, it is possible to make the STOAR element oscillate normally again, by boosting the STOAR element by a current.

### CROSS-REFERENCE TO RELATED APPLICATIONS

This application is a continuation of U.S. patent application Ser. No. 13/073,454, filed Mar. 28, 2011, which is based upon and claims the benefit of priority from Japanese Patent Application No. 2010-123535, filed May 28, 2010, the entire contents of each of which are incorporated herein by reference.

### FIELD

Embodiments described herein relate generally to a head IC and a magnetic disk apparatus, such as an HDD, which record data on a magnetic recording medium by using a microwave assistance function.

### BACKGROUND

In recent years, to deal with increased recording density of magnetic disk apparatuses such as HDDs, microwave assistance has attracted considerable attention. Microwave assistance is a technique of applying microwaves (a high-frequency magnetic field) to the surface of the medium in writing data, changing the surface of the medium to a state in which data can be easily written to the medium, and recording data on the surface. Microwave assistance is a function of applying a constant current bias to a STOAR element, thereby causing the element to oscillate at a frequency of the order of several tens of gigahertz and so output microwaves, reducing Hc of the medium and changing the medium to a state in which data can be easily written to the medium. Since the bias is a direct current, control thereof can be easily performed, and thus it is not difficult to provide the apparatus with the function. Therefore, microwave assistance is a function necessary for next-generation magnetic disk apparatuses.

STOAR elements oscillate at a frequency of the order of several tens of gigahertz. Since this oscillation generally has a frequency higher than that of a signal band of a transmission path of a head IC and the like, the oscillation signal is attenuated in the transmission path, and it is difficult to determine whether the element is oscillating properly.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram illustrating a main part of a disk drive 10 according to an embodiment.

FIG. 2 is a block diagram illustrating details of a head 13 and a head amplifier 14.

FIG. 3 is a diagram illustrating the principle of STOAR oscillation.

FIGS. 4A and 4B are diagrams illustrating the relationship between oscillation of a STOAR element and resistance.

FIG. 5 is a diagram illustrating the configuration of a circuit which checks oscillation of the STOAR element.

FIG. 6 is a diagram illustrating the circuit configuration of a second embodiment.

FIG. 7 is a diagram illustrating the circuit configuration of a third embodiment.

FIG. 8 is a diagram illustrating the circuit configuration of a fourth embodiment.

FIG. 9 is a diagram illustrating the circuit configuration of a fifth embodiment.

### DETAILED DESCRIPTION

Various embodiments will be described hereinafter with reference to the accompanying drawings.

In general, according to one embodiment, there is provided a head IC of a magnetic disk apparatus, which records data on a magnetic recording medium by using a microwave assistance function by a STOAR element, comprising a constant current source which supplies a constant current to the STOAR element, and a comparison module which compares a STOAR element voltage produced by the STOAR element with a predetermined voltage, and outputs a signal indicating that the STOAR element is not oscillating when the STOAR element voltage is lower than the predetermined voltage.

When the STOAR element oscillates when a current bias is applied to the STOAR element, the resistance of the element increases. This is the same as the mechanism of a GMR head or the like to which a bias current is applied. Therefore, the head IC which outputs a current bias senses a voltage applied to the STOAR element, and it is possible to determine that the STOAR element is oscillating when the voltage increases to a threshold value or more. Conversely, it is possible to determine that the STOAR element is not oscillating when the voltage is less than the threshold value. In addition, when the resistance decreases after the voltage reaches the certain threshold value or more, it is determined that oscillation of the element has diminished. Therefore, the STOAR element can be made to oscillate normally again by boosting the element by a current.

A magnetic disk apparatus according embodiments of the present invention will be explained hereinafter with reference to drawings.

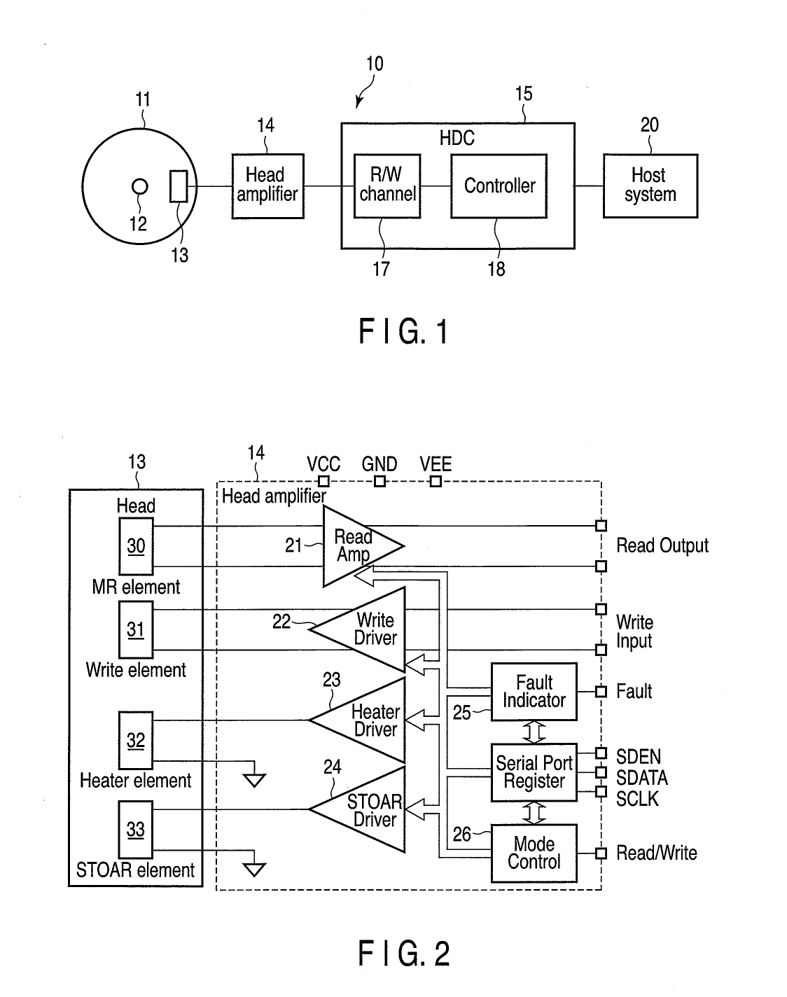

FIG. 1 is a block diagram illustrating a main part of a disk drive 10 according to the embodiment. The disk drive 10 of the embodiment comprises a disk 11 which is a magnetic recording medium, a spindle motor 12, a head 13, a head amplifier 14, and a hard disk controller (HDC, simply referred to as a “disk controller”). The spindle motor 12 rotates the disk 11. The head 13 includes a read head element and a write head element, reads data from the disk 11, and writes data to the disk 11.

The head amplifier 14 is generally structured as IC, amplifies a signal (read data) read by the head 13, and transmits the signal to the disk controller 15. In addition, the head amplifier 14 converts a signal (write data) output from the disk controller 15 into a write current, and transmits the current to the head 13.

The disk controller 15 includes a read/write channel 17 and a controller 18. The read/write channel 17 is a signal processing circuit for data recording and playback, and has a function of decoding read data which is read by the head 13, and encoding write data. The controller 18 is an interface which controls data transmission between the read/write channel 17 and a host system 20. In addition, the controller 18 controls data recording and playback operation through the read/write channel 17.

The host system 20 is a digital apparatus, such as a personal computer and a digital television, which uses the disk drive 10 as external storage element.

### Embodiment 1

FIG. 2 is a block diagram illustrating details of the head 13 and the head amplifier (head IC) 14.

First, the head amplifier 14 is explained.

A read amplifier 21 is an amplifier which amplifies a signal that is read from the recording medium by an MR element 30. The read amplifier 21 amplifies, for example, a signal of several mVpp to a signal of several hundred mVpp which an read channel following the read amplifier 21 can read. A write driver 22 is a driver which causes a current to flow through a write element 31, to write data to the recording medium. The write driver 22 causes, for example, a positive or negative current of several tens of milliamps to flow through the write head.

A heater driver 23 is a driver to cause a heater 32, which is included in the head 13, to produce heat. A STOAR driver 24 is a driver which supplies a current to make a STOAR element 33 oscillate. A fault indicator 25 has a function of detecting an abnormality of the head amplifier 14 and elements (such as the head) around the head amplifier 14. A serial port register 26 is a register for performing setting of the head amplifier. A mode controller 27 is a control section which switches writing and reading of a preamplifier.

Next, the head 13 is explained.

An MR element 30 is an element, the resistance of which changes according to the magnetic polarity (north/south) of the medium, such as a GMR head and a TMR head. A fixed current/voltage is applied to the MR element 30, and change in resistance thereof is converted to change in voltage/current. A write element 31 is an element (coil) to magnetize the recording medium. When a signal current flows through the write element 31, a magnetic field is produced in the coil, the recording medium is magnetized to have desired polarity, and thereby the signal is recorded on the medium. A heater element 32 produces heat and thereby causes the head to thermally expand, and controls the distance (flying height) from the surface of the medium to the head. The heater element 32 itself serves as resistor. A STOAR element 33 is a device through which a constant current flows during a write operation, and thereby an internal magnetization thereof oscillates at a frequency of several tens of gigahertz. Thereby, a high-frequency magnetic field of some several tens of gigahertz is applied to the medium, and magnetic particles of the medium resonate with the magnetic field, and become easily inverted. As a result, rewriting of data can be easily performed.

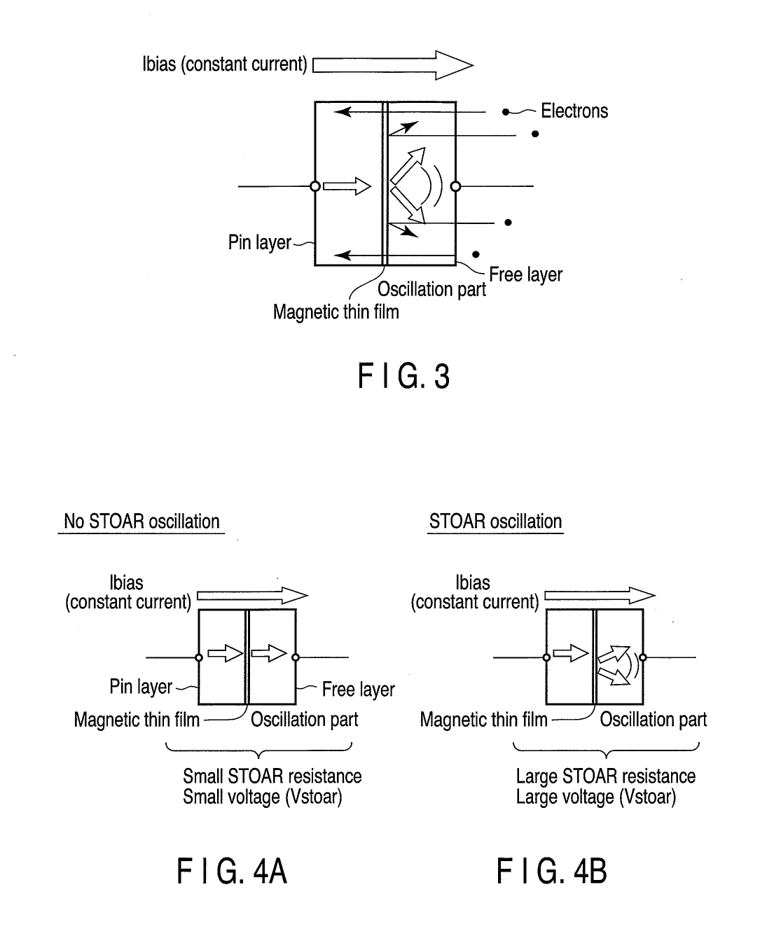

FIG. 3 is a diagram illustrating a principle of STOAR oscillation.

When electrons flow through a magnetic thin film, electrons whose direction of spin is the same as that of the magnetization of the magnetic material are easily transmitted through the film, and electrons whose direction of spin is different from that of the magnetization of the magnetic material are easily reflected. Magnetization of the free layer is rotated and made to oscillate by the reflected electrons. The oscillation frequency in this action is, for example, several tens of gigahertz. FIG. 4 is a diagram illustrating the relationship between oscillation of the STOAR element and the resistance.

When a high-frequency magnetic field at the resonant frequency of the magnetic material of the medium is applied to the medium, the magnetization of the medium oscillates, and the coercivity (Hc) of the medium decreases. In this state, data is written by the magnetic field of the write head. Then, when the high-frequency magnetic field is removed, the medium returns to have high Hc, and magnetization of the magnetic material is stabilized.

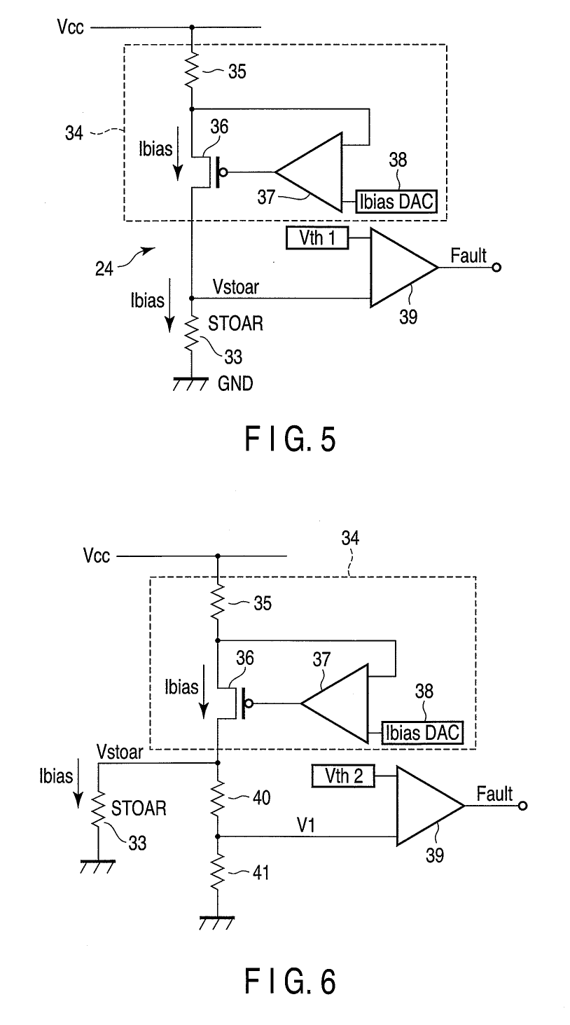

FIG. 5 is a diagram illustrating a configuration of a STOAR element oscillation checking circuit which checks whether the STOAR element is oscillating or not.

A constant current Ibias which is supplied from a constant current source 34 flows through the STOAR element 33. The constant current source 34 includes a resistor 35, a FET 36, a comparator 37, and an Ibias regulating DAC 38. To make the STOAR element 33 oscillate normally, it is necessary to cause a constant current Ibias of correct magnitude to flow through the element. Therefore, the magnitude of the constant current of the constant current source 34 is controlled by the DAC 38 in advance. The configuration of the constant current source 34 is not limited to the configuration illustrated in FIG. 5, but another general configuration is applicable as long as it can accurately regulate the constant current Ibias.

As described above, since the oscillation frequency of the STOAR element 33 is generally several tens of gigahertz, the oscillation signal is generally attenuated in the signal channel from the STOAR element 33 to a comparator 39. In addition, a general comparator which does not respond to signals of several tens of gigahertz is used as the comparator 39. A voltage Vstoar produced by the STOAR element 33 is applied to an inverting input terminal of the comparator 39. Therefore, the comparator 39 compares an average value Vstoar′ of voltage Vstoar with a threshold voltage Vth. When voltage Vstoar′ is greater than threshold voltage Vth1, the comparator 39 output goes low, for example, as signal Fault. When voltage Vstoar′ is less than threshold voltage Vth1, the comparator 39 output goes high. To remove the oscillation component and noise, voltage Vstoar may be input to the comparator 39 after passing through a low-pass filter.

As described above, the internal resistance of the STOAR element 33 during oscillation is higher than that during non-oscillation, and thus voltage Vstoar is relatively high. In this case, voltage Vstoar′ is greater than predetermined voltage Vth, and the comparator 39 output goes low, for example.

On the other hand, when oscillation of the STOAR element 33 has stopped or diminished, the internal resistance of the STOAR element 33 is less than that of the oscillating STOAR element 33, and thus voltage Vstoar is relatively low. In this case, voltage Vstoar′ is less than the predetermined voltage Vth, and the comparator 39 output goes high.

The STOAR element 33 is provided in the head 13 of FIG. 2, and the constant current source 34 and the comparator 39 correspond to the STOAR driver 24 of the head amplifier 24. Signal Fault is transmitted to the disk controller 15 through the fault indicator 25. In the disk controller 15, when a high signal is input as signal Fault, the controller 18 determines that oscillation of the STOAR element 33 has diminished or stopped, and controls the value of the Ibias DAC 38 of the constant current source 34, such that the STOAR element 33 oscillates normally again. Generally, the controller 18 increases constant current Ibias by setting a larger value than the present value for the Ibias DAC 38 of the constant current source 34. The DAC resetting operation is repeated until the STOAR element 33 oscillates normally.

As described above, according to the first embodiment, it is possible to check whether the element is oscillating or not in STOAR being a microwave assistance function, and resume normal oscillation under control of the controller 18 even when oscillation of the STOAR element has stopped.

### Embodiment 2

Next, a second embodiment of a STOAR element oscillation checking circuit according to the present invention will be explained hereinafter.

FIG. 6 illustrates a circuit configuration of the second embodiment.

In the circuit configuration, in addition to the configuration of the above first embodiment, a series circuit including a resistor 40 and a resistor 41 is connected between a constant current source 34 and GND. The other constituent elements are the same as those of the first embodiment. A voltage of a connecting point between resistor 40 and resistor 41 is input to a comparator 39. A voltage Vstoar of a STOAR element 33 is divided by resistors 40 and 41. A large value is applied to the values of resistor 40 and resistor 41, so as not to influence a current Ibias which flows through the STOAR element 33 as much as possible. The second embodiment has a structure which is effective when voltage Vstoar produced by the STOAR element 33 exceeds a proper input range of the comparator 39.

A voltage V1 which is obtained by dividing voltage Vstoar by the resistors 40 and 41 is represented by the following expression, where the voltage produced by the STOAR element 33 is Vstoar and the resistances of resistors 40 and 41 are R40 and R41, respectively.

V1=Vstoar·R41/(R40+R41)

The comparator 39 compares voltage V1 with a predetermined voltage Vth2, and outputs a signal Fault which indicates whether the STOAR element 33 is oscillating or not.

As described above, according to the second embodiment, even when voltage Vstoar which is produced by the STOAR element 33 exceeds the input range of the comparator 39, it is possible to check whether the STOAR element is oscillating or not, and resume oscillation of the STOAR element under control of the controller 18 even when oscillation of the STOAR element has stopped.

### Embodiment 3

Next, a third embodiment of a STOAR element oscillation checking circuit according to the present invention will be explained hereinafter.

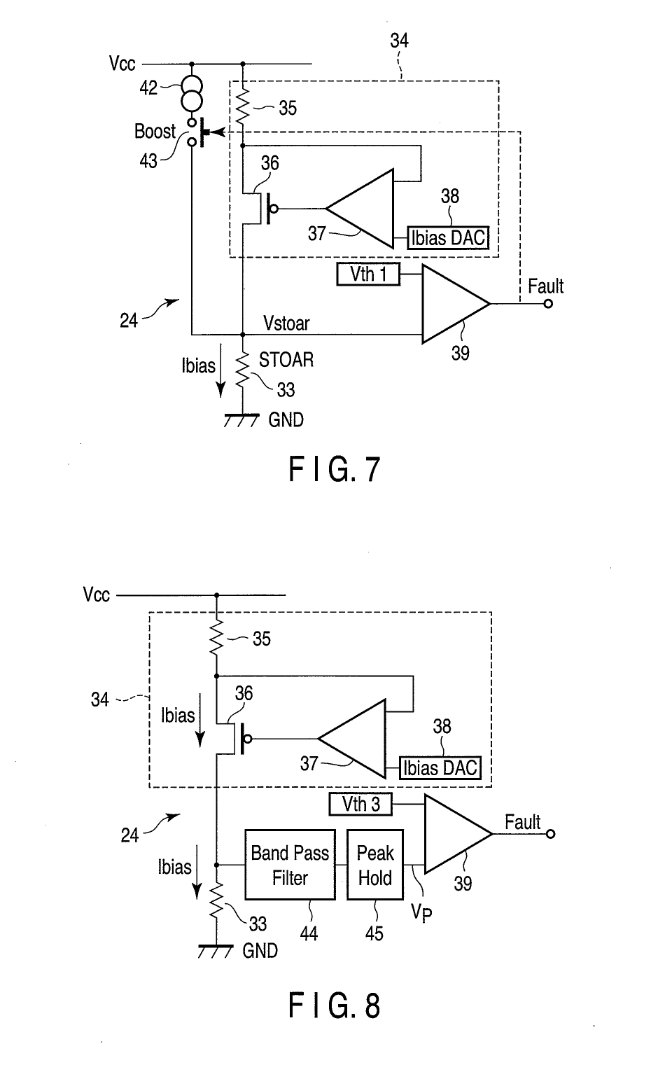

FIG. 7 illustrates a circuit configuration of the third embodiment.

In the circuit configuration, in addition to the configuration of the above first embodiment, a series circuit including a second constant current source 42 and a switch 43 is provided between a power voltage Vcc and a STOAR element 33. When oscillation of the STOAR element 33 has stopped or diminished, a high signal Fault is transmitted to the controller 18 as described above. In response to signal Fault, the controller 18 turns on the boost switch 43. As a result, a constant current of the second constant current source is added to a current which flows through the STOAR element 33. Therefore, the STOAR element 33 starts oscillation again.

As described above, according to the third embodiment, it is possible to check whether the STOAR element is oscillating or not, and resume oscillation of the STOAR element under control of the controller 18 even when oscillation of the STOAR element has stopped.

As a modification of the third embodiment, the output of a comparator 39 may be used as control input to the boost switch 43. In this case, when oscillation of the STOAR element 33 has stopped or diminished, for example, a high signal Fault is output from the comparator, and the boost switch 43 is turned on. As a result, the current which flows through the STOAR element 33 is increased, and oscillation of the STOAR element 33 is resumed.

According to the above modification, it is possible to check whether the STOAR element is oscillating or not, and resume oscillation of the STOAR element by the STOAR driver 24 itself even when oscillation of the STOAR element stops.

### Embodiment 4

Next, a fourth embodiment of a STOAR element oscillation checking circuit according to the present invention will be explained hereinafter.

FIG. 8 illustrates a circuit configuration of the fourth embodiment.

In the circuit configuration, in addition to the configuration of the above first embodiment, a series circuit including a bandpass filter (BPF) 44 and a peak hold circuit 45 is provided between a STOAR element 33 and a comparator 39. When the channel from the STOAR element 33 to the BPF 44 has good transmission efficiency, an oscillation signal of the STOAR element 33 reaches the BPF 44. The BPF 44 extracts and amplifies an oscillation band signal of the STOAR element 33.

The peak hold circuit 45 holds a peak value of an output signal of the BPF 44 for a predetermined time, and outputs a peak-held signal Vp. When the STOAR element 33 is oscillating, amplitude of signal Vp is higher than a predetermined threshold Th3. When oscillation of the STOAR element 33 stops, the amplitude of signal Vp is lower than predetermined threshold Th3. The comparator 39 compares signal Vp with predetermined threshold Th3, and outputs a comparison result as signal Fault.

Based on signal Fault, a controller 18 changes setting of an Ibias DAC as described above, and resumes oscillation of the STOAR element 33.

According to the fourth embodiment, it is possible to check whether the STOAR element is oscillating or not, and resume oscillation of the STOAR element under control of the controller 18 even when oscillation of the STOAR element has stopped.

### Embodiment 5

Next, a fifth embodiment of a STOAR element oscillation checking circuit according to the present invention will be explained hereinafter.

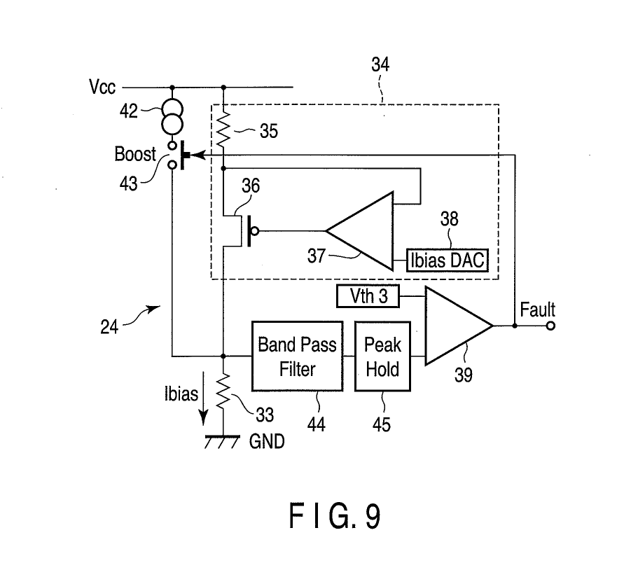

FIG. 9 illustrates a circuit configuration of the fifth embodiment.

The circuit configuration is obtained by combining the third embodiment with the fourth embodiment. Therefore, operation thereof is the same as those explained in the third and the fourth embodiments. Also in the fifth embodiment, it is possible to check whether the STOAR element is oscillating or not, and resume oscillation of the STOAR element by the STOAR driver 24 itself even when oscillation of the STOAR element has stopped.

As described above, according to the embodiments of the present invention, it is possible to detect that oscillation of the STOAR element has decreased or has stopped, and automatically perform continuous oscillation of microwaves and resumption of oscillation when the microwaves stop, by changing the setting of the constant current.

The above explanation is the embodiments of the present invention, and does not limit the apparatus or the method of the present invention, and various modified examples can be implemented. For example, as a modification of the present invention, it is possible to change the invention to a method of directly checking change of the resistance, by obtaining not only the voltage but also the current of the STOAR element and converting them to a resistance by a divider.

The above description is the embodiments of the present invention, and the apparatus and the method of the present invention are not limited thereto, and various modified examples can be implemented. Such modified examples are included in the present invention. Further, apparatuses or methods which are configured by appropriately combining the components, the functions, the features, or the steps of the method in respective embodiments are included in the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk apparatus comprising:
a head comprising a microwave-assistance element;
a head amplifier comprising: a current source configured to supply current; and a detection module configured to compare a threshold voltage and an element voltage generated at the microwave-assistance element when the current source supplies the current to the microwave-assistance element, and to detect that the element voltage is lower than the threshold voltage, the head amplifier being connected to the head; and
a controller configured to increase an amount of the current to be supplied to the microwave-assistance element when the detection module of the head amplifier detects that the element voltage is lower than the threshold voltage.

2. The magnetic disk apparatus of claim 1, wherein:
the element voltage is a voltage which generates at the microwave-assistance element based on a resistance value of the microwave-assistance element; and
the element voltage being lower than the threshold voltage comprises that the microwave-assistance element is not oscillating.

3. The magnetic disk apparatus of claim 1, wherein the controller is configure to instruct the head amplifier to increase an amount of output current of the current source, when the detection module detects that the element voltage is lower than the threshold voltage.

4. The magnetic disk apparatus of claim 1, further comprising a first and a second resistor elements connected in series with each other and also connected in parallel with the microwave-assistance element,
wherein the detection module is configure to compare a voltage of a connecting part between the first and the second resistor elements with the threshold voltage.

5. The magnetic disk apparatus of claim 1, wherein the head amplifier further comprises a second current source and a switch connected between the second current source and the microwave-assistance element, and is configured to turn on the switch when the element voltage is lower than the threshold voltage.

6. The magnetic disk apparatus of claim 1, further comprising:
a bandpass filter configured to filter the element voltage; and
a peak hold circuit configured to hold a peak value of an output voltage of the bandpass filter;
wherein the detection module is configured to compare an output signal of the peak hold circuit with the threshold voltage.

7. The magnetic disk apparatus of claim 2, wherein the controller is configure to instruct the head amplifier to increase an amount of output current of the current source, when the detection module detects that the element voltage is lower than the threshold voltage.

8. The magnetic disk apparatus of claim 2, further comprising a first and a second resistor elements connected in series with each other and also connected in parallel with the microwave-assistance element,
wherein the detection module is configure to compare a voltage of a connecting part between the first and the second resistor elements with the threshold voltage.

9. The magnetic disk apparatus of claim 2, wherein the head amplifier further comprises a second current source and a switch connected between the second current source and the microwave-assistance element, and is configure to turn on the switch when the element voltage is lower than the threshold voltage.

10. The magnetic disk apparatus of claim 2, further comprising:
a bandpass filter configured to filter the element voltage; and
a peak hold circuit configured to hold a peak value of an output voltage of the bandpass filter;
wherein the detection module is configured to compare an output signal of the peak hold circuit with the threshold voltage.

11. A method of controlling current to be supplied to a microwave-assistance element of a magnetic disk apparatus which comprises a head and a head amplifier, the head comprising the microwave-assistance element, the head amplifier comprising a current source to supply current and being connected to the head, the method comprising:
comparing a threshold voltage and an element voltage generated at the microwave-assistance element when the current source supplies the current to the microwave-assistance element; and
increasing an amount of the current to be supplied to the microwave-assistance element when it is detected that the element voltage is lower than the threshold voltage.

12. The method of claim 11, wherein:
the element voltage is a voltage which generates at the microwave-assistance element based on a resistance value of the microwave-assistance element; and
the element voltage being lower than the threshold voltage comprises that the microwave-assistance element is not oscillating.

13. The method of claim 11, wherein increasing the current comprises increasing an amount of output current of the current source, when it is detected that the element voltage is lower than the threshold voltage.

14. The method of claim 11, wherein the head amplifier further comprises a second current source and a switch connected between the second current source and the microwave-assistance element, and the method further comprising: turning on the switch when the element voltage is lower than the threshold voltage.

15. A head amplifier connected to a head provided at a magnetic disk apparatus, the head amplifier comprising:
a current source configured to supply current to a microwave-assistance element provided at the head;
a comparison module configured to compare a threshold voltage and an element voltage generated at the microwave-assistance element when the current source supplies the current to the microwave-assistance element; and
a detection module configured to detect, from a result of comparison by the comparison module, that the element voltage is lower than the threshold voltage,
wherein the current source is configured to increase an amount of the current to be supplied to the microwave-assistance element when the detection module detects that the element voltage is lower than the threshold voltage.

16. The head amplifier of claim 15, wherein:
the element voltage is a voltage which generates at the microwave-assistance element based on a resistance value of the microwave-assistance element; and
the element voltage being lower than the threshold voltage comprises that the microwave-assistance element is not oscillating.

17. The head amplifier of claim 15, wherein the current source is configure to increase an amount of output current to increase the amount of the current to be supplied to the microwave-assistance element, when the detection module detects that the element voltage is lower than the threshold voltage.

18. The head amplifier of claim 15, further comprising a first and a second resistor elements connected in series with each other and also connected in parallel with the microwave-assistance element,
wherein the comparison module is configure to compare a voltage of a connecting part between the first and the second resistor elements with the threshold voltage.

19. The head amplifier of claim 15, further comprising a second current source and a switch connected between the second current source and the microwave-assistance element, and is configure to turn on the switch to increase the amount of the current to be supplied to the microwave-assistance element, when the element voltage is lower than the threshold voltage.

20. The head amplifier of claim 15, further comprising:
a bandpass filter configured to filter the element voltage; and
a peak hold circuit configured to hold a peak value of an output voltage of the bandpass filter;
wherein the comparison module is configured to compare an output signal of the peak hold circuit with the threshold voltage.
